(19) United States
(12) Patent Application Publication
(10) Pub. No.: US 2018/0367968 A1
(43) Pub. Date: Dec. 20, 2018

(54) FIRE CHIEF MOBILE COMMAND CONTROL CENTER

(71) Applicant: Honeywell International Inc., Morris Plains, NJ (US)

(72) Inventor: Gary Donald Golichowski, Russia, OH (US)

(21) Appl. No.: 15/626,717

(22) Filed: Jun. 19, 2017

(51) Int. Cl. H04W 4/22; H04B 1/713; H04M 1/725; G06Q 10/06; H04W 4/02; G08G 5/00

(52) U.S. Cl. CPC H04W 4/22; H04B 1/713; H04M 1/72536; G08G 5/0073; H04W 4/023; H04M 1/72555; G08G 5/0069; G06Q 10/063114

(57) ABSTRACT

Embodiments relate generally to systems and methods for responding to emergency situations. An emergency response system may comprise a plurality of communication devices accessible by emergency personnel; and a secured wireless network accessible, with an access code, to the plurality of communication devices, wherein the plurality of communication devices are configured to communicate, with each other, information related to an emergency situation; wherein the secured wireless network is a frequency-hopping spread spectrum network.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

In many emergency situations, first responders and other emergency personnel must work quickly and efficiently to manage and monitor any incident. The emergency personnel may need to capture accurate and current information relating to the emergency situation, and then may disseminate this information to first responders on the ground responding to the emergency situation. Effective communication may be critical to both effective firefighting and the safety of emergency personnel who may work in any hazardous environment.

### SUMMARY

In an embodiment, an emergency response system may comprise a plurality of communication devices accessible by emergency personnel; and a secured wireless network accessible, with an access code, to the plurality of communication devices, wherein the plurality of communication devices are configured to communicate, with each other, information related to an emergency situation; wherein the secured wireless network is a frequency-hopping spread spectrum network.

In an embodiment, a method for accessing an emergency response network may comprise obtaining an access code, with at least one communication device, for access to a secured wireless network; and accessing the secured wireless network with the at least one communication device, wherein the at least one communication device is accessible by emergency personnel; wherein the secured wireless network is a frequency-hopping spread spectrum network.

In an embodiment, a method for communicating over an emergency response network may comprise obtaining an access code, with at least one communication device, for access to a secured wireless network, wherein the secured wireless network is a frequency-hopping spread spectrum network; accessing the secured wireless network with the at least one communication device, wherein the at least one communication device is accessible by emergency personnel; capturing images, with the at least one communication device, of an emergency situation; sending captured images, with the at least one communication device, of the emergency situation to other communication devices on the secured wireless network; and communicating a strategy, with the at least one communication device, to resolve the emergency situation based on the captured images.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a schematic illustration of an emergency response network in accordance with embodiments of the disclosure.

FIG. 2 is another schematic illustration of an emergency response network in accordance with embodiments of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or “approximately” or the like, when used with a number, may mean that specific number, or alternatively, a range in proximity to the specific number, as understood by persons of skill in the art field; and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

The safety of firefighters and citizens may depend upon reliable, functional communication tools (e.g., radios) that may work in the harshest and most hostile of environments. Many firefighters, professional and volunteer, may operate in extreme environments that may be markedly different from those of any other radio users. The radio (e.g., very high frequency (“VHF”)) may be the lifeline that may connect the firefighters to outside assistance when in the most desperate of situations. VHF may include frequencies from about 30 megahertz (“MHz”) to about 300 MHz. To operate safely in these dynamic environments, it may be imperative that firefighters have the ability to immediately communicate information accurately.

Emergency situations/incidents may be handled via an emergency call (e.g., a mayday call; the mayday call may often be the “last chance” to get outside assistance, and emergency personnel may be listening for that call of distress). Emergency personnel may include employees of a hospital; police; fire department; a dispatch office; emergency medical technicians (“EMTs”); and firefighters. The location of a person in need of help, and the location of the nearest emergency responder that can help, may not be known via radio. Also, when a second crew (e.g., multiple alarm fire) is needed, the officer in command/incident commander (“IC”) can contact a dispatch office and request another company, but IC can't track/monitor its arrival and direct it to the most advantageous location prior to it arriving on the scene. This may be a waste of precious time, and quick response is critical. IC may be an employee of any emergency department or entity involved in an emergency situation (e.g., hospital), and may be in charge of the emergency situation.

Further, IC cannot share real time pictures and information via a radio. That is, the radio communication utilized currently may be outdated and inefficient (e.g., VHF). Further, utilizing radios to share information may be inefficient due to noise (e.g., traffic) on the radio and the possibility of misinformation or partial information sharing.

The ability for a dispatch office, hospital(s), firefighter(s), EMT(s), and police to communicate, may be dependent upon whether the various emergency departments/entities involved, share the same radio system.

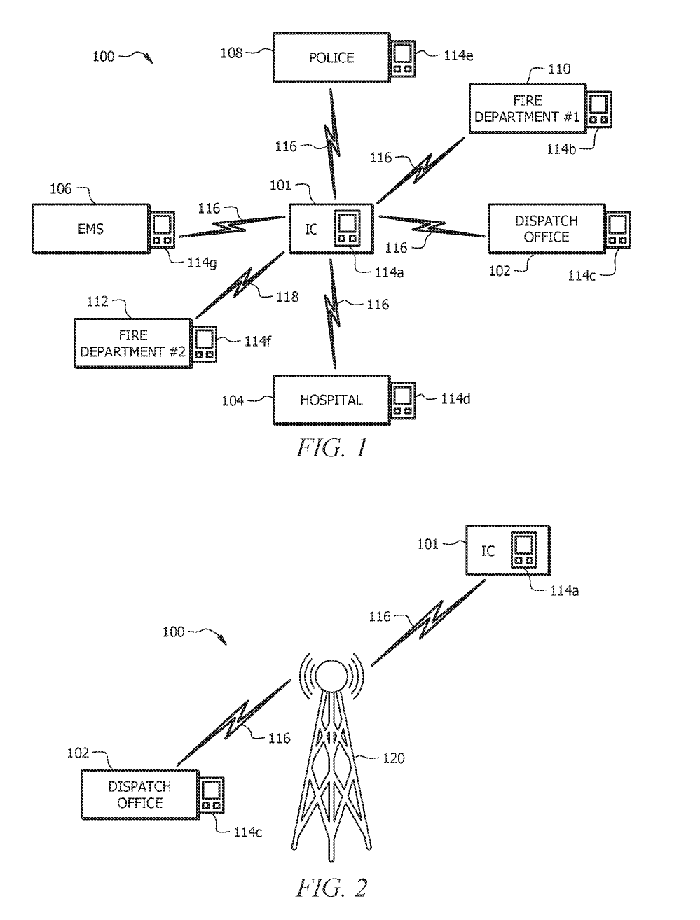

Also, a radio network (e.g., VHF) utilized by emergency personnel may allow anyone including non-emergency personnel to access and communicate on the radio network during an incident by selecting a specific channel or radio frequency. In contrast to a radio network, systems and methods of the disclosure may incorporate a secure network which may require an access code (i.e., accessible by authorized users). Emergency personnel may communicate on an unsecure radio network (e.g., VHF) by choosing a particular channel/frequency with a communication device, and may also separately communicate on a secured network (e.g., network 100, shown on FIGS. 1 and 2) with a communication device.

Embodiments of the disclosure may relate to a private communication network to allow communication between emergency personnel (e.g., a dispatch office, emergency medical services (“EMS”), firefighter(s), hospital(s) and/or police). If injured people can be triaged, and the hospital knows multiple injured victims are in route, there can be time saving measures implemented to help. The ability to locate down/injured emergency personnel (e.g., a firefighter) when he/she cannot communicate can be lifesaving. An ability to check for arrival of emergency personnel and an ability to direct the emergency personnel prior to arrival can buy critical time to resolve the emergency, improve effectiveness, and/or reduce loss of property and/or lives.

FIG. 1 is a schematic illustration of network 100 (e.g., an emergency response network). Network 100 may be a self-contained, privately owned and managed mobile network based on ultra high frequency (“UHF”) (e.g., bluetooth, WiFi, 4G, etc.), super high frequency (“SHF”), extremely high frequency (“EHF”), and/or terahertz or tremendously high frequency (“THz” or “THF”) wireless protocols. UHF may include frequencies from about 300 MHz to about 3000 MHz. SHF may include frequencies from about 3 gigahertz (“GHz”) to about 30 GHz. EHF may include frequencies from about 30 GHz to about 300 GHz. THz or THF may include frequencies from about 300 GHz to about 3000 GHz.

Network 100 may be a secure (e.g., restricted access) communication network between various emergency departments/entities (e.g., emergency personnel), such as, for example, IC 101, dispatch office 102, hospital 104, EMS 106, police 108, fire department 110 (e.g., a first fire department) and/or fire department 112 (e.g., a second fire department). Network 100 may provide communications services between closed communities of users, such as, for example, emergency personnel. Network 100 may be accessible by emergency personnel via at least one communication device (e.g., a wireless device or a wired device). A communication device (e.g., communication devices 114a-114g), may include any suitable device, such as, for example, a smartphone, a portable electronic device, a computer (e.g., a desktop computer, a laptop computer, a mobile computer), a drone, or combinations thereof. Each communication device may allow communication on network 100 between each of the emergency departments/entities. That is, the various departments/entities may have access to a communication device that may be connected to network 100. For example, a firefighter may carry the communication device. Communication devices 114a-114g may also each comprise a communication module (e.g., a radio frequency module, a transceiver), a global positioning system (“GPS”), a computer, a camera (e.g., digital, thermal imaging, video camera, etc.), a keyboard, a microphone, a speaker, a user interface, or combinations thereof. In certain embodiments, communication devices 114a-114g may each comprise the drone for navigating (e.g., flying) around an emergency incident and capturing images and/or video of the emergency incident with a camera. Data transmitted over the network can include voice, text, images, video, and various biological parameters (e.g., heart rate, breathing, motion, and the like) of various emergency workers.

Network 100 may be a frequency-hopping spread spectrum (“FHSS”) network. That is, network 100 may allow a transmission of signals by rapidly switching frequency channels, using an order/sequence/pattern known to both a transmitter and a receiver (e.g., communication devices 114a-114g). FHSS may be a wireless technology that may spread its signal(s) over rapidly changing frequencies during transmission of the signal(s) in order to reduce interference and avoid interception. Each available frequency band may be divided into sub-frequencies. Signals may quickly change (“hop”) among these frequencies/sub-frequencies in a pre-determined order/sequence/pattern. Interference at a specific frequency may only affect the signal during that interval. Cryptographic techniques (e.g., encryption) may be utilized to generate the channel order/sequence/pattern via an access code that a sender and receiver may share in advance (e.g., via a communication device). FHSS may counter eavesdropping, obstruct jamming of telecommunications, and can minimize effects of unintentional interference. In addition FHSS allows multiple networks to be established in overlapping geographic areas without communications on the networks interfering with each other.

Dispatch office 102 may originate and assign an access code for each emergency situation/incident. That is, dispatch office 102 may generate and/or send the access code, via a communication device (e.g., communication device 114c), to the emergency personnel involved in the incident (e.g., a specific group), such as, for example, IC 101, hospital 104, EMS 106, police 108, fire department 110 (e.g., a first fire department) and/or fire department 112 (e.g., a second fire department). The access code can include the FHSS pattern needed by each device in order to receive and send communications on the hopping pattern. For example, the access code can include a code indicative of a frequency-time code over which a specific FHSS network operates. All entities within the specific group may have a common access code to enable the devices to communicate. For example, the dispatch office 102 may communicate via the communication device 114c; the IC 101 may communicate via the communication device 114a; the hospital 104 may communicate via the communication device 114d; the EMS 106 may communicate via the communication device 114g; the police 108 may communicate via the communication device 114e; the fire department 110 may communicate via the communication device 114b; and the fire department 112 may communicate via the communication device 114f. The entities with the same access code may communicate with each other on network 100 via their respective communication devices.

While any device can initially establish an access code, the IC may generate and send the access code in some embodiments. This may be similar to inviting participant to join the private network. Once the access code is received by the emergency personnel, via a communication device, the emergency personnel may access network 100 by selecting network 100 from a list of networks in a user interface of the communication device, and selecting the access code within the user interface. In some embodiments, the IC 101 may communicate with the emergency personnel, and the emergency personnel may communicate with each other via the IC 101. That is, the IC 101 may be a central hub allowing communication between the emergency personnel. In other embodiments in which the devices are within range of each other, direct device-to-device communication may be possible on the FHSS network.

Dispatch office 102 may generate/assign multiple access codes for sub-groups of emergency personnel, where any given emergency personnel device can have an access code for one or more FHSS networks. Only emergency personnel with the same access code can communicate with each other via network 100. That is, there may be a dedicated communication FHSS network (e.g., a network based on a pre-determined frequency order/pattern/sequence) for each access code (e.g., the communication network 116 and the communication network 118). There may be no cross communication between these mutually exclusive communication networks (e.g., communication network 116 and communication network 118) as the two networks may not be transmitting/receiving on the same frequencies at the same times.

Network(s) 100 may allow only emergency personnel to utilize these networks which may benefit a possible scenario where more than one emergency situation/event/incident occurs nearby and during an overlapping time window. The various resources (e.g., IC 101, dispatch office 102, hospital 104, EMS 106, police 108, fire department 110 (e.g., a first fire department) and/or fire department 112 (e.g., a second fire department)) may function (e.g., communicate) without overlapping communications and may reduce information flow to the various resources working an emergency situation, without external interference. Once a resource is no longer required at a first event (e.g., an emergency situation/incident), dispatch office 102 may redirect a resource (e.g., via invite) to a second event, with another access code (e.g., an access code unique to the second event). The freed up resource may become part of the second event, and may communicate with resources at the second event. This may facilitate coordination of the resources and may also serve as a buffer to prevent too many victims from being sent to just one hospital (e.g. hospital 104) and overwhelming the hospital staff. Dispatch office 102 may have the ability to help coordinate between the resources and redirect the closest resources to the emergency situation because needs may change during the event(s).

FIG. 2 illustrates another schematic of network 100 (e.g., a cellular network). In certain embodiments, network 100 may include network tower 120. At least one of the communication devices 114a-114g (e.g., communication devices 114a and 114c) may be connected to network 100 via network tower 120. The IC 101 (via the communication device 114a) may communicate with at least one of the communication devices 114b-114g (e.g., the communication device 114c) via the communication network 116. In certain embodiments, an invitation/invite (e.g., for joining the network 100) including the access code may be sent (e.g., via a voice call, text, email, and/or electronic message) from at least one communication device. For example, the IC 101 may send an invite to each of the emergency departments/entities via communication device 114a. Once on the network 100, the emergency personnel (i.e., the users) may communicate with one another and may capture and send images of an emergency situation in real time. That is, emergency personnel may capture images of an emergency situation (e.g., a burning house) and communicate (e.g., via a voice call, text, email, and/or electronic message/chat), via a communication device, a strategy for attending to and resolving the emergency situation based on the images. Also, via a communication device, emergency personnel may notify (e.g., via a voice call, text, email, and/or electronic message/chat) a hospital (e.g., hospital 104) regarding a number of injured people, types of injuries, condition of injured people, an estimated time of arrival (“ETA”) to the hospital, or combinations thereof. The hospital may be notified via at least one communication device before the injured people are transported to the hospital. Additionally, via the network 100, emergency personnel may track/locate/monitor (e.g., via GPS) another person who is communicating with the communication device. For example, an injured firefighter may be located within a burning structure due to the communication device he/she may be carrying.

As part of the communication scheme using the FHSS network, the IC 101 may be in charge of dynamically grouping sub-networks to link the communications over two or more sub-networks. This may allow groups to be connected as needed and then subsequently un-grouped to avoid overcrowding the channels.

As noted above, the use of FHSS networks for emergency personnel provides a dynamic and efficient system to provide selective and private networks to be established within an incident and/or between incidents. The ability to provide private networks may eliminate overcrowded networks that can mask individual communications. Further, such networks are safer from potential security intrusions and eavesdropping from unauthorized personnel.

Having described various systems and methods, various embodiments can include, but are not limited to:

In a first embodiment, an emergency response system may comprise a plurality of communication devices accessible by emergency personnel; and a secured wireless network accessible, with an access code, to the plurality of communication devices, wherein the plurality of communication devices are configured to communicate, with each other, information related to an emergency situation; wherein the secured wireless network is a frequency-hopping spread spectrum network.

A second embodiment may include the emergency response system of the first embodiment, wherein the plurality of communication devices comprises a smartphone, a drone, a portable electronic device, a desktop computer, a laptop computer, a mobile computer, or combinations thereof.

A third embodiment may include the emergency response system of the first or second embodiment, wherein the secured wireless network is accessible, due to the access code, by a hospital, a fire department, a police department, a dispatch office, and/or emergency medical services.

A fourth embodiment may include the emergency response system of any of the preceding embodiments, wherein the secured wireless network is an ultra high frequency network.

A fifth embodiment may include the emergency response system of any of the preceding embodiments, wherein the plurality of communication devices are configured to communicate via a text, a voice call, an email, and/or a chat.

A sixth embodiment may include the emergency response system of any of the preceding embodiments, wherein the plurality of communication devices is configured to capture images and/or video of an emergency situation with a camera or similarly capable device.

A seventh embodiment may include the emergency response system of any of the preceding embodiments, wherein the plurality of communication devices is configured to send the images and/or video of the emergency situation.

An eighth embodiment may include the emergency response system switch of any of the preceding embodiments, wherein each communication device comprises a global positioning system configured to track the emergency personnel.

A ninth embodiment may include the emergency response system of any of the preceding embodiments, wherein the information related to an emergency situation comprises a number of injured people, types of injuries, condition of injured people, an estimated time of arrival to the hospital, or combinations thereof.

A tenth embodiment may include the emergency response system of any of the preceding embodiments, wherein at least one communication device from the plurality of communication devices is configured to send an invite, with the access code, to other communication devices.

In an eleventh embodiment, a method for accessing an emergency response network may comprise obtaining an access code, with at least one communication device, for access to a secured wireless network; and accessing the secured wireless network with the at least one communication device, wherein the at least one communication device is accessible by emergency personnel; wherein the secured wireless network is a frequency-hopping spread spectrum network.

A twelfth embodiment may include the method of the eleventh embodiment, further comprising sending, with the at least one communication device, an invite to join the secured wireless network.

A thirteenth embodiment may include the method of the eleventh or twelfth embodiments, further comprising inputting the access code into a user interface of the at least one communication device to provide access to the secured wireless network.

A fourteenth embodiment may include the method of any one of the eleventh through thirteenth embodiments, further comprising directing emergency personnel from a first emergency situation to a second emergency situation by sending, with the at least one communication device, a second invite containing a second access code unique to the second emergency situation.

A fifteenth embodiment may include the method of any one of the eleventh through fourteenth embodiments, further comprising capturing images and/or video, with the at least one communication device, of an emergency situation, and sending captured images and/or video of the emergency situation to other communication devices on the secured wireless network.

In a sixteenth embodiment, a method for communicating over an emergency response network may comprise obtaining an access code, with at least one communication device, for access to a secured wireless network, wherein the secured wireless network is a frequency-hopping spread spectrum network; accessing the secured wireless network with the at least one communication device, wherein the at least one communication device is accessible by emergency personnel; capturing images, with the at least one communication device, of an emergency situation; sending captured images, with the at least one communication device, of the emergency situation to other communication devices on the secured wireless network; and communicating a strategy, with the at least one communication device, to resolve the emergency situation based on the captured images.

A seventeenth embodiment may include the method of the sixteenth embodiment, further comprising tracking a location of the at least one communication device with a global positioning system.

An eighteenth embodiment may include the method of the sixteenth or seventeenth embodiment, further comprising notifying, via the at least one communication device, a hospital regarding a number of injured people, types of injuries, condition of injured people, and/or an estimated time of arrival to the hospital, before the injured people are transported to the hospital.

A nineteenth embodiment may include the method of any one of the sixteenth through eighteenth embodiments, further comprising navigating, with the at least one communication device, around the emergency situation; wherein the at least one communication device comprises a drone.

A twentieth embodiment may include the method of any one of the sixteenth through nineteenth embodiments, further comprising allowing communication among a plurality of communication devices without overlapping communications.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as “comprises,” “includes,” and “having” should be understood to provide support for narrower terms such as “consisting of,” “consisting essentially of,” and “comprised substantially of.” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1. An emergency response system comprising:
a plurality of communication devices accessible by emergency personnel; and
a secured wireless network accessible, with an access code common to the plurality of communication devices, to the plurality of communication devices, wherein the plurality of communication devices are configured to communicate, with each other, information related to an emergency situation, wherein the information related to the emergency situation comprises contextual biological motion of an emergency worker;
wherein the secured wireless network is a frequency-hopping spread spectrum network,
wherein the access code is related to a frequency-time code over which the frequency-hopping spread spectrum network operates.

2. The system of claim 1, wherein the plurality of communication devices comprises a smartphone, a drone, a portable electronic device, a desktop computer, a laptop computer, a mobile computer, or combinations thereof.

3. The system of claim 2, wherein the secured wireless network is accessible, due to the access code, by a hospital, a fire department, a police department, a dispatch office, and/or emergency medical services.

4. The system of claim 3, wherein the secured wireless network is an ultra high frequency network.

5. The system of claim 4, wherein the plurality of communication devices are configured to communicate via a text, a voice call, an email, and/or a chat.

6. The system of claim 5, wherein the plurality of communication devices is configured to capture images and/or video of an emergency situation with a camera or similarly capable device.

7. The system of claim 6, wherein the plurality of communication devices is configured to send the images and/or video of the emergency situation.

8. The system of claim 7, wherein each communication device comprises a global positioning system configured to track the emergency personnel.

9. The system of claim 8, wherein the information related to an emergency situation comprises a number of injured people, types of injuries, condition of injured people, an estimated time of arrival to the hospital, or combinations thereof.

10. The system of claim 9, wherein at least one communication device from the plurality of communication devices is configured to send an invite, with the access code, to other communication devices.

11. A method for accessing an emergency response network, the method comprising:
obtaining an access code, with at least one communication device, for access to a secured wireless network; and
accessing the secured wireless network with the at least one communication device, wherein the at least one communication device is accessible by emergency personnel;
wherein the secured wireless network is a frequency-hopping spread spectrum network,
wherein the access code is related to a frequency-time code over which the frequency-hopping spread spectrum network operates,
wherein the at least one communication device is configured to communicate, with at least one other communication device, information related to an emergency situation,
wherein the information related to the emergency situation comprises contextual biological motion of an emergency worker.

12. The method of claim 11, further comprising sending, with the at least one communication device, an invite to join the secured wireless network.

13. The method of claim 12, further comprising inputting the access code into a user interface of the at least one communication device to provide access to the secured wireless network.

14. The method of claim 13, further comprising directing emergency personnel from a first emergency situation to a second emergency situation by sending, with the at least one communication device, a second invite containing a second access code unique to the second emergency situation.

15. The method of claim 14, further comprising capturing images and/or video, with the at least one communication device, of an emergency situation, and sending captured images and/or video of the emergency situation to other communication devices on the secured wireless network.

16. A method for communicating over an emergency response network, the method comprising:
obtaining an access code common to a plurality of communication devices, with at least one communication device of the plurality of communication devices, for access to a secured wireless network, wherein the secured wireless network is a frequency-hopping spread spectrum radio network;
accessing the secured wireless network with the at least one communication device, wherein the at least one communication device is accessible by emergency personnel;
capturing images, with the at least one communication device, of an emergency situation;
sending captured images, with the at least one communication device, of the emergency situation to other communication devices of the plurality of communication devices on the secured wireless network via direct device-to-device communication over the frequency-hopping spread spectrum radio network; and
communicating a strategy, with the at least one communication device, to resolve the emergency situation based on the captured images
wherein the plurality of communication devices are configured to communicate, with each other, information related to an emergency situation,
wherein the information related to the emergency situation comprises contextual biological motion of an emergency worker.

17. The method of claim 16, further comprising tracking a location of the at least one communication device with a global positioning system.

18. The method of claim 17, further comprising notifying, via the at least one communication device, a hospital regarding a number of injured people, types of injuries, condition of injured people, and/or an estimated time of arrival to the hospital, before the injured people are transported to the hospital.

19. The method of claim 18, further comprising navigating, with the at least one communication device, around the emergency situation; wherein the at least one communication device comprises a drone.

20. The method of claim 19, further comprising allowing communication among a plurality of communication devices without overlapping communications.
